(19) United States
(12) Patent Application Publication
(10) Pub. No.: US 2015/0240658 A1
(43) Pub. Date: Aug. 27, 2015

(54) Carbon Nanotubes for Increasing Vibration Damping In Polymer Matrix Composite Containment Cases for Aircraft Engines

(71) Applicant: UNITED TECHNOLOGIES CORPORATION, (US)

(72) Inventor: Sreenivasa R. Voleti, Farmington, CT (US)

(73) Assignee: UNITED TECHNOLOGIES CORPORATION, Hartford, CT (US)

(21) Appl. No.: 13/632,362

(22) Filed: Oct. 1, 2012

(51) Int. Cl. F01D 25/04; F01D 25/00; C08L 63/00; C08K 7/06; C08K 7/14; F01D 25/24; F02C 3/04

(52) U.S. Cl. CPC F01D 25/04; F01D 25/24; F01D 25/005; F02C 3/04; C08K 7/06; C08K 7/14; C08L 63/00; F05D 2220/32; F05D 2260/96; F05D 2300/43; F05D 2300/44; F05D 2300/603; C08L 2205/16

(57) ABSTRACT

A gas turbine engine has a fan section having a fan with a plurality of fan blades and a containment case surrounding the fan blades. The containment case is formed from a polymer matrix material containing carbon, glass and aramid fibers, and carbon nanotubes for improving vibration damping.

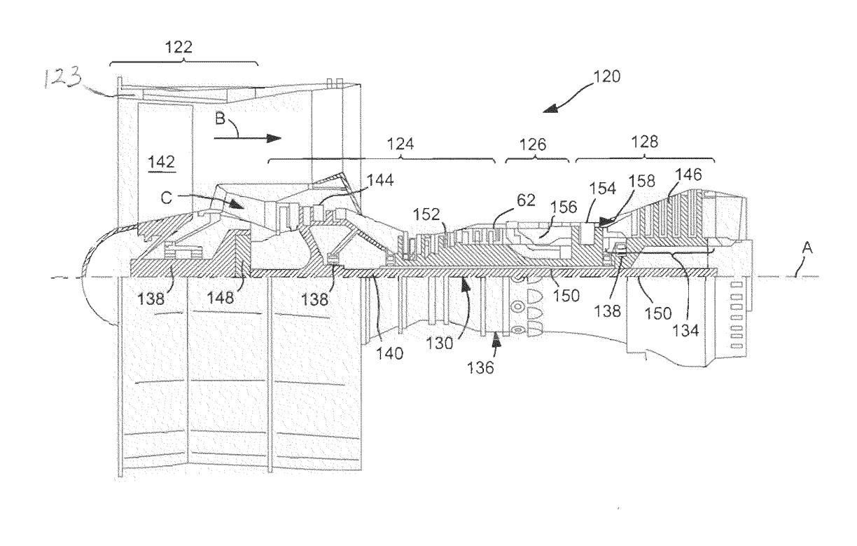

### BACKGROUND

The present disclosure relates to the use of carbon nanotubes in polymer matrix composites used for a gas turbine engine containment case to improve vibration damping.

Damping of vibrations in an engine is a desirable feature, and in some cases, a critical requirement. Mechanical vibrations and acoustic vibrations (noise) are a constant feature of engine function. Methods to damp out the mechanical and acoustic vibrations can improve the engine performance, engine life and reduce environmental impact (lower noise).

### SUMMARY

In accordance with the present disclosure, there is provided a gas turbine engine which broadly comprises: a fan section having a fan with a plurality of fan blades and a containment case surrounding the fan blades; and the containment case being formed from a polymer matrix material containing carbon nanotubes for improving damping.

In another and alternative embodiment, the polymer matrix material comprises a matrix material with the carbon nanotubes being embedded within the matrix material.

In another and alternative embodiment, the matrix material comprises a thermoset resin.

In another and alternative embodiment, the thermoset resin is an epoxy resin.

In another and alternative embodiment, the matrix material also contains fibers in an amount from 45 to 70% fiber volume fraction.

In another and alternative embodiment, the fibers are selected from the group consisting of Fiberglass fibers, aramid fibers and carbon fibers.

In another and alternative embodiment, the carbon nanotubes are uniformly dispersed within the matrix material.

In another and alternative embodiment, the carbon nanotubes have a length in the range of from 5.0 nanometers to 100 nanometers.

In another and alternative embodiment, the carbon nanotubes have a diameter in the range of from 5.0 nanometers to 50 nanometers.

In another and alternative embodiment, the carbon nanotubes are present in an amount from 0.2 to 5.0 wt %.

In another and alternative embodiment, the carbon nanotubes have varying lengths.

In another and alternative embodiment, the carbon nanotubes have varying diameters.

Further in accordance with the present disclosure, there is provided a composite material for use as a containment case, which composite material broadly comprises: a matrix material having carbon nanotubes embedded therein in an amount from 0.2 to 5.0 wt %.

In another and alternative embodiment, the matrix material comprises a thermoset resin.

In another and alternative embodiment, the thermoset resin is an epoxy resin.

In another and alternative embodiment, the composite material further comprises a plurality of fibers within the matrix material.

In another and alternative embodiment, the fibers are present in an amount from 45 to 75% fiber volume fraction.

In another and alternative embodiment, the fibers are selected from the group consisting of Fiberglass fibers, aramid fibers and carbon fibers.

In another and alternative embodiment, the carbon nanotubes have a length in the range of from 5.0 nanometers to 100 nanometers and a diameter in the range of from 5.0 nanometers to 50 nanometers.

In another and alternative embodiment, the carbon nanotubes have varying diameters.

In another and alternative embodiment, the carbon nanotubes have varying lengths.

Other details of the carbon nanotubes for increasing vibration damping in polymer matrix composite containment cases for a jet engine are set forth in the following detailed description and the accompanying drawing wherein like reference numerals depict like elements.

### BRIEF DESCRIPTION OF THE DRAWINGS

The FIGURE illustrates a sectional view of a gas turbine engine.

### DETAILED DESCRIPTION

Referring now to the FIGURE, there is shown an example gas turbine engine 120 that includes a fan section 122, a compressor section 124, a combustor section 126 and a turbine section 128. Alternative engines might include an augmenter section (not shown) among other systems or features. The fan section 122 includes a containment case 123 surrounding the fan which may have a plurality of fan blades 146. The fan section 122 drives air along a bypass flow path B while the compressor section 124 draws air in along a core flow path C where air is compressed and communicated to a combustor section 126. In the combustor section 126, air is mixed with fuel and ignited to generate a high pressure exhaust gas stream that expands through the turbine section 128 where energy is extracted and utilized to drive the fan section 122 and the compressor section 124.

Although the disclosed non-limiting embodiment depicts a turbofan gas turbine engine, it should be understood that the concepts described herein are not limited to use with turbofans as the teachings may be applied to other types of turbine engines; for example a turbine engine including three spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 120 generally includes a low speed spool 130 and a high speed spool 132 mounted for rotation about an engine central longitudinal axis A relative to an engine static structure 136 via several bearing systems 138. It should be understood that various bearing systems 138 at various locations may alternatively or additionally be provided.

The low speed spool 130 generally includes an inner shaft 140 that connects a fan 142 and a low pressure (or first) compressor section 144 to a low pressure (or first) turbine section 146. The inner shaft 140 drives the fan 142 through a speed change device, such as a geared architecture 148, to drive the fan 142 at a lower speed than the low speed spool 130. The high speed spool 132 includes an outer shaft 150 that interconnects a high pressure (or second) compressor section 152 and a high pressure (or second) turbine section 154. The inner shaft 140 and the outer shaft 150 are concentric and rotate via the bearing systems 138 about the engine central longitudinal axis A.

A combustor 156 is arranged between the high pressure compressor 152 and the high pressure turbine 154. In one example, the high pressure turbine 154 includes at least two stages to provide a double stage high pressure turbine 154. In another example, the high pressure turbine 154 includes only a single stage. As sued herein, a “high pressure” compressor or turbine experiences a higher pressure than a corresponding “low pressure” compressor or turbine.

The example low pressure turbine 146 has a pressure ratio that is greater than about 5. The pressure ratio of the example low pressure turbine 146 is measured prior to an inlet of the low pressure turbine 146 as related to the pressure measured at the outlet of the low pressure turbine 146 prior to an exhaust nozzle.

A mid-turbine frame 158 of the engine static structure 136 is arranged generally between the high pressure turbine 154 and the low pressure turbine 146. The mid-frame turbine 158 further supports bearing systems 138 in the turbine section 128 as well as setting airflow entering the low pressure turbine 146.

The core airflow C is compressed by the low pressure compressor 144 then by the high pressure compressor 152 mixed with fuel and ignited in the combustor 156 to produce high speed exhaust gases that are then expanded through the high pressure turbine 154 and low pressure turbine 146. The mid-turbine frame 158 includes vanes 160, which are in the core airflow path and function as an inlet guide vane for the low pressure turbine 146. Utilizing the vane 160 of the mid-turbine frame 158 as the inlet guide vane for low pressure turbine 146 decreases the length of the low pressure turbine 146 without increasing the axial length of the mid-turbine frame 158. Reducing or eliminating the number of vanes in the low pressure turbine 146 shortens the axial length of the turbine section 128. Thus, the compactness of the gas turbine engine 120 is increased and a higher power density may be achieved.

The disclosed gas turbine engine 120 in one example is a high-bypass geared aircraft engine. In a further example, the gas turbine engine 120 includes a bypass ratio greater than about six, with an example embodiment being greater than about ten. The example geared architecture 148 is an epicyclical gear train, such as a planetary gear system, star gear system or other known gear system, with a gear reduction ratio of greater than about 2.3.

In one disclosed embodiment, the gas turbine engine 120 includes a bypass ratio greater than about 10:1 and the fan diameter is significantly larger than an outer diameter of the low pressure compressor 144. It should be understood however that the above parameters are only exemplary of one embodiment of a gas turbine engine including a geared architecture and that the present disclosure is applicable to other gas turbine engines.

The example gas turbine engine includes the fan 142 that comprises in one non-limiting embodiment less than about twenty-six fan blades. In another non-limiting embodiment, the fan section 122 includes less than about twenty fan blades. Moreover, in one disclosed embodiment, the low pressure turbine 146 includes no more than about six turbine rotors schematically illustrated at 134. In another non-limiting example embodiment, the low pressure turbine 146 includes about three turbine rotors. A ratio between the number of fan blades 142 and the number of low pressure turbine rotors is between about 3.3 and about 8.6. The example low pressure turbine 146 provides the driving power to rotate the fan section 122 and therefore the relationship between the number of turbine rotors 134 in the low pressure turbine 146 and the number of blades 142 in the fan section 122 discloses an example gas turbine engine 120 with increased power transfer efficiency.

Different components within the gas turbine engine 120 may be made from polymer-matrix composites or organo-matrix composites. These composites may be composed of fibers, such as carbon or glass fibers, and a thermosetting resin, such as an epoxy resin, forming the matrix material. These composites may be used to form engine components such as the containment case 123, liners, fiberglass facesheets, and splitters. Thermoset resins, such as epoxy resins, have damping properties given their viscoelastic nature. To further enhance the damping effect provided by such composites, carbon nanotubes may be added to, or embedded in, the thermoset resin matrix material to improve the damping properties. Such carbon nanotubes may be present in an amount from 0.2 to 5.0 wt %. Furthermore, the carbon nanotubes may be uniformly dispersed throughout the matrix material.

Carbon nanotubes are advantageous to use because they have a large surface area to weight ratio. This enables a greater area for friction between the nanotubes and the resin which forms the matrix material. This is an additional mechanism for damping, over and above the viscoelasticity of the resin. The degree of damping can be varied by varying the length and/or diameters of the nanotubes. The carbon nanotubes may have a length in the range from 5.0 nanometers to 100 nanometers. Further, the carbon nanotubes may have a diameter in the range of from 5.0 nanometers to 50 nanometers.

Furthermore, the composite material forming the containment case may include Fiberglass fibers, aramid fibers or carbon fibers embedded in the matrix material. The Fiberglass fibers, aramid fibers or carbon fibers may be present in an amount from 45 to 70% fiber volume fraction.

The resin material which forms the matrix material may comprise a thermoset resin such as an epoxy resin, RTM-6, and variants thereof. Additives may be added to improve properties of the composite material such as fracture toughness if needed.

In one non-limiting exemplary composition, the composite material has 1.0 wt % carbon nanotubes in a carbon fiber-epoxy composite with 55% volume fraction of the carbon fibers.

There has been provided in accordance with the present disclosure carbon nanotubes for providing improved damping in polymer matrix composite containment cases for jet engines. While the present invention has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. A gas turbine engine comprising:
a fan section having a plurality of fan blades and a containment case surrounding said fan; and
said containment case being formed from a polymer matrix material containing carbon nanotubes for improving damping.

2. The gas turbine engine of claim 1, wherein said polymer matrix material comprises a matrix material with said carbon nanotubes being embedded within said matrix material.

3. The gas turbine engine of claim 2, wherein said matrix material comprises a thermoset resin.

4. The gas turbine engine of claim 3, wherein said thermoset resin is an epoxy resin.

5. The gas turbine engine of claim 2, wherein said matrix material also contains fibers in an amount from 45 to 70% fiber volume fraction.

6. The gas turbine engine of claim 5, wherein said fibers are selected from the group consisting of Fiberglass fibers, aramid fibers and carbon fibers.

7. The gas turbine engine of claim 2, wherein said carbon nanotubes are uniformly dispersed within said matrix material.

8. The gas turbine engine of claim 1, wherein said carbon nanotubes have a length in the range of from 5.0 nanometers to 100 nanometers.

9. The gas turbine engine of claim 1, wherein said carbon nanotubes have a diameter in the range of from 5.0 nanometers to 50 nanometers.

10. The gas turbine engine of claim 1, wherein said carbon nanotubes are present in an amount from 0.2 to 5.0 wt %.

11. The gas turbine engine of claim 1, wherein said carbon nanotubes have varying lengths.

12. The gas turbine engine of claim 1, wherein said carbon nanotubes have varying diameters.

13. A composite material for use as a containment case, said composite material comprising:
a matrix material having carbon nanotubes embedded therein in an amount from 0.2 to 5.0 wt %.

14. The composite material of claim 13, wherein said matrix material comprises a thermoset resin.

15. The composite material of claim 14, wherein said thermoset resin is an epoxy resin.

16. The composite material of claim 13, further comprising a plurality of fibers within said matrix material.

17. The composite material of claim 16, wherein said fibers are present in an amount from 45 to 75% fiber volume fraction.

18. The composite material of claim 16, wherein said fibers are selected from the group consisting of Fiberglass fibers, aramid fibers and carbon fibers.

19. The composite material of claim 13, wherein said carbon nanotubes have a length in the range of from 5.0 nanometers to 100 nanometers and a diameter in the range of from 5.0 nanometers to 50 nanometers.

20. The composite material of claim 13, wherein said carbon nanotubes have varying lengths.

21. The composite material of claim 13, wherein said carbon nanotubes have varying diameters.
